(19) United States
(12) Patent Application Publication
(10) Pub. No.: US 2008/0312965 A1
(43) Pub. Date: Dec. 18, 2008

(54) MEDICAL COMPLIANCE SOFTWARE BASED SYSTEM AND COMPUTER WRITEABLE MEDIUM

(76) Inventor: Zubin Meshginpoosh, Suwanee, GA (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/762,341

(22) Filed: Jun. 13, 2007

(51) Int. Cl. G06Q 50/00; G06F 17/30

(52) U.S. Cl. 705/3; 707/104.1

(57) ABSTRACT

A software based medical compliance system including a physician accessible computer in communication with an electronic medical records (EMR) database for storing, in digitized form, a patient's medical information including at least a prescription medication portfolio. A plurality of software template screens link the physician computer to the EMR database and provide an ability to upload medication related information. A process server is in operative communication with the EMR database and receives a packet of digitized information incorporating any subset amount of information relative to the patient. The process server issues a wireless communication to a suitable patient accessible device relative to the packet of information.

### FIELD OF THE INVENTION

The present invention discloses a physician accessible and updatable database of patient medical information which, in cooperation with an interactive process server, issues a wireless medication reminder message to a patient (via any communication device not limited to a suitable wireless device or other land communication means). Such messages can include regimen instruction, as well as advance notification of refill or any other relevant medical information. A backup storage device, such as a thumb drive or flash drive (USB) and/or a barcode keychain accessible means which allows a patient to retain a portable and updatable electronic record, such as by other specialists and physicians, and which can upload further revisions to the host server. A separate software link with a physician desk reference would fill in any incomplete information not provided by the physician and according to a plurality of templates or software based subroutines for inputting information for constructing a complete health care portfolio not limited to prescription medication.

### DESCRIPTION OF THE PRIOR ART

The prior art is well documented with various examples of medication event monitoring and updating devices. The objective in each instance is to promote adherence to a patient medication regimen.

A first example of the prior art is set forth in Kilton et al., U.S. Pat. No. 6,198,695, and which teaches a subscription based device and associated method for monitoring patient compliance with a medication regimen. The apparatus component includes a specifically designed portable device having a microcontroller with memory for storing the event times and descriptions. A prompting means built into the device alerts the patient and a microphone feature allows the patient to record verbal messages for later replay by a clinician. The associated method for monitoring patient compliance includes the steps of a) programming the device with event times and descriptions; b) comparing the event times to a system time; c) alerting the patient when an event is about to occur; d) pausing the alert; e) waiting a predetermined amount of time; and f) acknowledging the alerting after the alert is paused and before the end of the predetermined amount of time.

U.S. Pat. No. 6,985,869, issued to Stoll et al., discloses a digital prescription carrier and monitor system including a pager sized carrier apparatus with an internal processor, a real-time clock/calendar, a non-volatile memory, a communication port, a character display, and alert devices. Prescription data or one or more medications is stored within the carrier by a physician and downloaded by a pharmacist to fill the prescriptions called for. The carrier apparatus requires the entry of a decryption key to access prescription data within the carrier to prevent unauthorized access or tampering with the prescription data. The carrier apparatus also functions as a prescription reminder to the patient and records compliance with the prescription, since a switch must be operated to quiet an alert device activated when a scheduled medication dose is due.

U.S. Pat. No. 5,950,632, issued to Reber et al., discloses a medical communication apparatus having a receiver for receiving a message and at least one output device responsive to the receiver. The output device generates an alert for taking a first medicine and a second medicine in response to the message, and graphically indicates the first and second medicines.

U.S. Patent Application Publication No. 2003/0086338, to Sastry et al., shows a wireless, web based system for monitoring patient drug compliance and which includes a plastic container that holds a wireless device, the patient's drugs, and a CPU programmable remotely and automatically from a normal computer input by health care providers and pharmacists to control the functioning of the wireless transceiver and a variety of sound, vibration, light and readable screen for reminders and to provide drug related information. A sensor detects and wirelessly reports the opening of the medicine container in real time to remind the patient, when noncompliance occurs, on the patient's portable device and also telephone or pages the patient as additional reminders. The web site program analyzes models and interprets the data to provide important drug noncompliance information to health care professionals. The container may further comprise a sensor means for temperature, blood pressure, and blood chemistry data including blood glucose, creatinine and others which may be transmitted wirelessly.

Additional examples of prior art references of note include Goetz et al., U.S. Pat. No. 6,421,560 and which teaches a medication management system for assisting in patient control, monitoring and management of administration of prescribed medications. A patient component includes a retrievable patient database of patient medical history, including prior prescribed medications and current prescribed medications and further including a data transfer interface. A physician component includes a likewise retrievable database of medical information and input/output device enabling a prescribing physician to enter prescription information into the physician component. The physician's database is further capable of receiving and storing patient data transferred from said patient component through said data transfer interface. Finally, a pharmacist computer accessible component is adapted to interface with the patient component to transfer prescription data to said pharmacist component.

U.S. Statutory Invention Registration No. H1782, to Wicks et al., teaches a medication notification system using a wireless paging receiver to alert a patient concerning the time or times a specific medication is to be taken. The pharmacy filling the original prescription provides the relevant information as to the kind of medication, dosage and frequency to the paging dispatch center at the time the prescription is filled. The data is stored at the paging dispatch center and automatically transmitted to the paging receiver at the appropriate time. A two-way system is also provided in which, in addition to receiving the instructions relating to taking medications, allows the patient to transmit health-related information back to his or her health care provider.

Finally, U.S. Pat. No. 6,909,359. issued to McGovern, teaches a real time computerized medical alerting system which collates medical prescription information such as provided by commercial retail pharmacies to customized schedules for administration of medication and therapy to patients. The system broadcasts reminder information via radio frequency wireless transmissions over a wide area network subsystem to portable receivers uniquely associated with specific patients. The patients receive real time reminders directed only to them to take medicine. Patients receive only their own respective reminders and do not obtain reminders for other patients who subscribe to the system.

### SUMMARY OF THE PRESENT INVENTION

The present invention discloses a physician accessible and updatable database of patient medical information capable of issuing a medication reminder to an existing patient digital receiving communication (wireless) device, e.g. PDA, cell phone or the like. The physician updatable and computerized database incorporates a plurality of software template screens linking the physician's computer with an electronic medical records (EMR) database. The EMR database in turn is in cooperation with an interactive process server which issues a wireless medication reminder message or any other suitable health care related instructions to the suitable communication (wireless) device. Such messages can also include regimen instruction, as well as advance notification of refills or other health related instructions.

Additional features include a backup storage device, such as a thumb drive or flash drive (USB), which allows a patient to retain a portable and updatable electronic record. A barcode readable device can also be employed to access or update the desired electronic record. The portable USB drive can be provided to other specialists and physicians, and which can be utilized to upload further revisions to the host server. A separate software link with a physician desk reference would fill in any incomplete information not provided by the physician.

The present invention also includes a physician accessible and computer writeable medium for assembling, uploading and communicating a patient prescription portfolio. The computer writeable medium, or suitable software module, includes a plurality of subroutines for inputting a patient identity, assembling a listing of all medications currently being prescribed to the patient, assigning a total number of pills per medication prescription, authorizing a total number of refills, and issuing a wireless communication incorporating a packet of digitized information, assembled from the various subroutines, to a patient accessible device. Also, the system and associated computer writeable medium can be used to provide other health care related instructions from the physician/provider to the patient.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a diagram illustrating the interactive components including the physician PC, electronic medical records database software, wirelessly transmitting process server and patient PDA/cell phone; and

FIG. 2 is an EMR patient prescription notification process flow diagram and which further describes a medication informational update and notification protocol according to the present inventions.

### DETAILED DESCRIPTION OF THE PREFERRED EMBODIMENTS

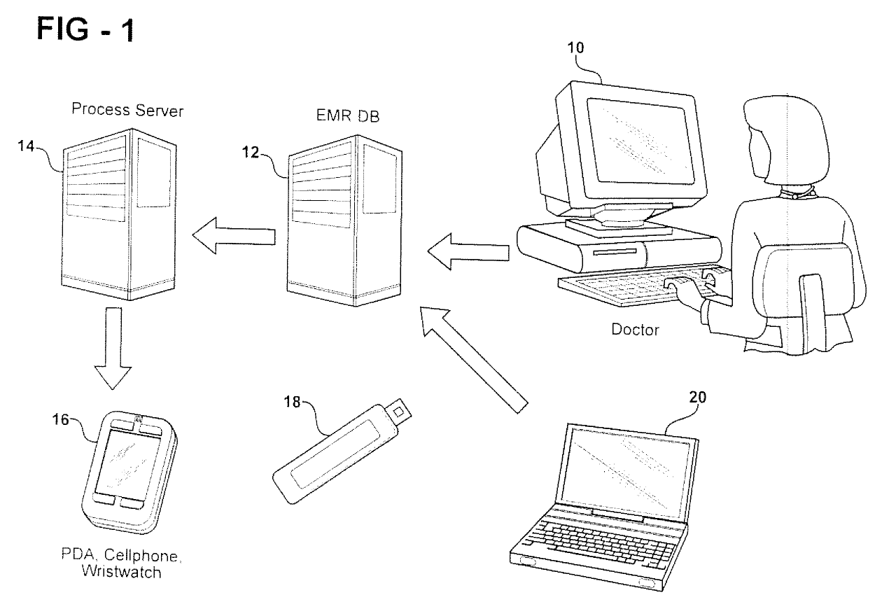

Referring to FIG. 1, a diagrammatic illustration is most generally shown of an interactive and medical compliance system according to the present invention. As previously described, the present invention operates to both assemble a prescription medication portfolio, at the physician level, and to interact with a wireless transmitting medication reminder server in communication with an existing patient digital receiving wireless device, e.g. PDA, cell phone or the like, as well as any suitable land communication means.

As will be also described, the present invention likewise discloses a physician updatable and computerized database incorporating a plurality of software template screens linking the physician's computer with an electronic medical records (EMR) database. The EMR database in turn is in cooperation with an interactive process server which issues a wireless medication remainder message to the suitable wireless device. Such messages can include regimen instruction, as well as advance notification of refills, and other health care related instructions.

Referring to FIG. 1, a physician accessible computer is generally represented at 10 in communication with an electronic medical records (EMR) database 12 for storing in digitized format, a patient's medical information, also termed as a prescription medication portfolio. As will be further described in reference to the computer writeable medium forming a part of the present invention, a plurality of software template screens are provided which link the physician computer 10 to said EMR database and providing an ability to upload medication related information.

A process server 14 is provided in operative communication with the EMR database 12, such as via a dedicated data transfer line or, even wirelessly, and receives a packet of digitized information incorporating any subset amount of information relative to the patient. The process server 14 in turn issues a wireless communication to a patient accessible device, generally referenced at 16, and relative to the packet of information being transmitted to the patient. Again, it is understood that additional means not limited to wireless phones and pagers may be employed for receiving physician/provider instructions.

The packet of digitized information is capable of being transmitted in one version is a text message to a patient accessible device, and which may include a PC e-mail account associated with one of a desktop computer, a laptop computer and a personal digital assistant (PDA). The packet of digitized information can alternatively be transmitted as an instant message to a patient accessible device, and which includes at least one of a cellular telephone, pager and a wearable wristwatch device.

The prescription medication portfolio further includes such as a listing of all patient medications, milligram strengths, dosage strengths and frequencies, pill descriptions and refill dates and may also include a medication regimen reminder and a refill reminder. The medication regimen reminder further includes at least one of a medicine brand name and molecular name, a milligram strength and dosing frequency, and pill description. The refill reminder further may include a notice issued by the process server, up to one week prior to a scheduled refill date.

Additional features of the present system include a patient provided and portable USB drive 18 (such as a flash drive or thumb drive), and which contains a backup copy of the prescription medication portfolio. A barcode/key code reader can also be employed. A secondary physician accessible computer, as shown at 20 and which may represent such another medical specialist or physician, can be presented with the USB drive 18 and, with it selectively update and upload, to the EMR database 12, information relative to the patient prescription medication portfolio and in augmenting fashion relative to the information originally prepared and uploaded by the primary physician 10.

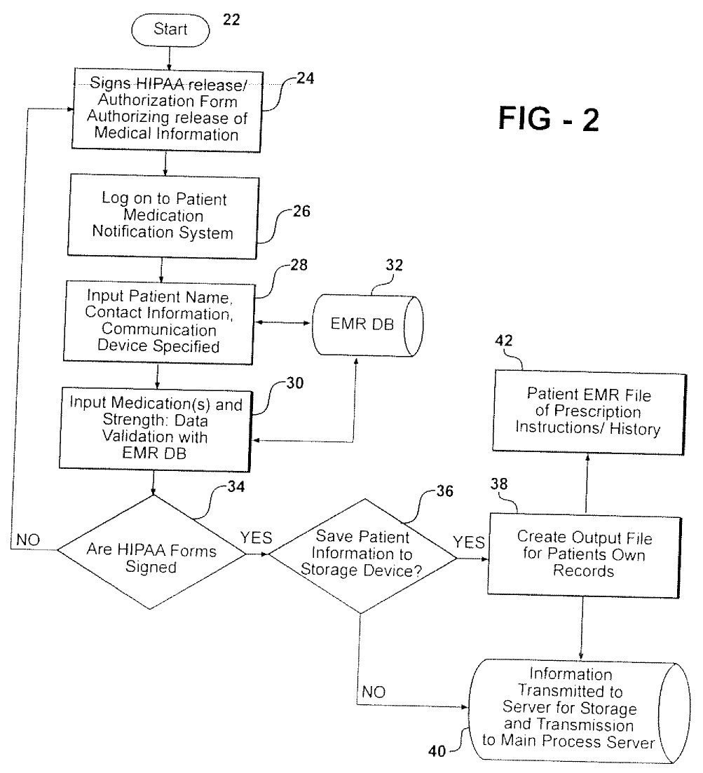

Referring now to FIG. 2, an EMR patient prescription notification process flow diagram is shown for further explaining a medication informational update and notification protocol according to the present invention. In particular, step 22 initiates a patient driven component of the process and by which a suitable HIPPA or like consent form 24 is executed and recorded. At 26, a first step of physician/prescribing health care provider driven component includes logging on to a patient medication notification system.

At subsequent step 28, a patient's name, contact information, specified patient communication (e.g. wireless) device and the like are inputted. Additional and subsequent input information, at step 30, includes medication type (e.g. pill description by color and/or molecular/brand name), dosage strength (in milligrams), and the like. The EMR database is represented at 32 and interfaces with steps 28 and 30. Progressing linearly from step 30, at 34, a query is made as to whether the patient consent (HIPPA) forms are signed and recorded. If no, the process routes back to step 24 previously described.

Step 36 queries whether to save the patient assembled information to a dedicated storage device (i.e., whether the patient has authorized the information to be sent to the sever for participation in the reminder program). If yes, subsequent step 38 creates an output file for the patient's own records, as well as issuing the assembled portfolio to the process server. If no, step 40 transmits the information to storage in a patient's existing electronic medical record. Finally, step 42 progresses from step 38 and provides a patient EMR file of prescriptions, instructions and history previously assembled (e.g. on such as a portable flash/thumb USB type drive).

The present invention also discloses an associated and physician accessible and assembleable computer writeable medium for assembling, uploading and communicating a patient prescription portfolio. This most generally includes such as a first subroutine for inputting a patient identity, a second subroutine for assembling a listing of all medications currently being prescribed to the patient, a third subroutine for assigning a total number of pills per medication prescription, a fourth subroutine for authorizing a total number of refills, and a fifth subroutine for issuing a wireless communication incorporating a packet of digitized information, assembled from the first through fourth subroutines, to a patient accessible device.

Template screens are associated with one or more of each of the computer writeable subroutines, for assembling said patient prescription portfolio. The first subroutine may further include inputting the patient's last name, first name and middle initial. The second subroutine further includes a first dropdown menu of all FDA approved drugs, automatically narrowed upon key entering of a selected brand or generic item.

Additional features of the second subroutine can also include a second dropdown menu of all available milligram strengths associated with a prescription selected in the first dropdown menu, as well as, upon selecting a specified milligram strength, inputting a physical description of a designated medication into the prescription portfolio from an informational database. A third dropdown window associated with the second subroutine includes providing a plurality of choices for a number of times a day the patient is to take a selected prescription and including at least one of “Q.D.” (once daily), “B.I.D.” (twice daily), “T.I.D.” (three times daily), “Q.I.D.” (four times daily), “AM/PM“, “With meals”, and “Before bed”.

An additional subroutine communicates a warning in the event of a determined drug interaction situation involving more than one selected medication, this possibly including an outside piece of conventional software which, such as the informational software plug in for assembling general information relative to a selected type of medication, can be interfaced with the prescription medication portfolio to be assembled. Such software is understood to link with the physician desk reference in order to fill in any incomplete information not provided by the physician.

Yet additional features include the fourth subroutine exhibiting an additional subset routine for generating at least one refill date based upon a selected dosing regimen and number of pills. Finally, an additional subset routine can query whether a patient consent (HIPPA) form is on file prior to communicating, to an intermediate electronic medical records database, the informational packet constructed by the first, second, third and fourth subroutines.

The present invention accordingly provides a novel and unique physician assembleable and controllable system for establishing a medication reminder portfolio combined with a wireless transmission assembly for effectively and timely issuing both regimen and refill to the patient it is contemplated that sales support for the system would in large part come from existing pharmaceutical-economic data, and that demonstrates a cost savings for a patient/health care system that is compliant with medical therapy considerations; i.e., avoiding hospitalization complications and associated expenses arising therefrom resulting from disease and due to improper disease/medication management.

Having described my invention, other and additional preferred embodiments will become apparent to those skilled in the art to which it pertains, and without deviating from the scope of the appended claims.

I claim;

1. A software based medical compliance system, comprising:
a physician accessible computer in communication with an electronic medical records (EMR) database storing, in digitized form, a patient's medical information including at least a patient's health care portfolio;
a plurality of software template screens linking said physician computer to said EMR database and providing, an ability to upload medication related information; and
a process server in operative communication with said EMR database and receiving a packet of digitized information incorporating any subset amount of information relative to the patient, said process server issuing a wireless communication to a patient accessible device relative to said packet of information.

2. The medical compliance system as described in claim 1, said patient's health care portfolio further comprising a prescription medication portfolio listing all of a patient's medications, milligram, strengths, dosage strengths and frequencies, pill descriptions and refill dates.

3. The medical compliance system as described in claim 2, said packet of digitized information issued by said process server further comprising at least one of a medication regiment reminder and a refill reminder.

4. The medical compliance system as described in claim 3, said medication regimen reminder further comprising at least one of a medicine brand name and molecular name, a milligram strength and dosing frequency, and pill description.

5. The medical compliance system as described in claim 3, said refill reminder further comprising a notice issued by said process server up to one week prior to a scheduled refill date.

6. The medical compliance system as described in claim 2, further comprising a patient provided and portable USB drive containing a backup copy of said prescription medication portfolio.

7. The medical compliance system as described in claim 6, further comprising a secondary physician accessible computer for selective updating and uploading, to said EMR database, information relative to said patient prescription medication portfolio.

8. The medical compliance system as described in claim 1, further comprising said packet of digitized information being transmitted as a text message to a patient accessible device which includes a PC e-mail account associated with one of a desktop computer, a laptop computer and a personal digital assistant (PDA).

9. The medical compliance system as described in claim 1, further comprising said packet of digitized information being transmitted as an instant message to a patient accessible device which includes at least one of a cellular telephone, pager and a wearable wristwatch device.

10. A physician accessible and computer writeable medium for assembling, uploading and communicating a patient health care portfolio, comprising:
a first subroutine for inputting a patient identity;
a second subroutine for assembling a listing of all medications currently being prescribed to the patient;
a third subroutine for assigning a total number of pills per medication prescription;
a fourth subroutine for authorizing a total number of refills; and
a fifth subroutine for issuing, a wireless communication incorporating a packet of digitized information, assembled from said first through fourth subroutines, to a patient accessible device.

11. The computer writeable medium as described in claim 10, further comprising at least one template screen associated with each of said subroutines and for assembling said patient portfolio.

12. The computer writeable medium as described in claim 10, said first subroutine further comprising inputting the patient's last name, first name and middle initial.

13. The computer writeable medium as described in claim 10, said second subroutine further comprising a first dropdown menu of all FDA approved drugs, automatically narrowed upon key entering of a selected brand or generic item.

14. The computer writeable medium as described in claim 13, said second subroutine further comprising a second dropdown menu of all available milligram strength is associated with a prescription selected in said first dropdown menu.

15. The computer writeable medium as described in claim 13, said second routine further comprising, upon selecting a specified milligram strength, inputting a physical description of a designated medication into said prescription portfolio from an informational database.

16. The computer writeable medium as described in claim 14, said second subroutine further comprising a third dropdown window providing a plurality of choices for a number of times a day the patient is take a selected prescription and including, at least one of “Q.D.” (once daily, “B.I.D.” (twice daily), “T.I.D.” (three times daily), “Q.I.D.” (four times daily), “AM /PM”, “With meals”, and “Before bed”.

17. The computer writeable medium as described in claim 16, further comprising an additional subroutine communicating a warning in the event of a determined drug interaction situation involving more than one selected medication.

18. The computer writeable medium as described in claim 10, said fourth subroutine further comprising an additional subset routine for generating, at least one refill date based upon a selected dosing regiment and number of pills.

19. The computer writeable medium as described in claim 10, further comprising an additional subset routine for querying whether a patient consent (HIPPA) form is on file prior to communicating to an intermediate electronic medical records database, said informational packet constructed by said first, second, third and fourth subroutines.

20. A software based medical compliance system, comprising:
a physician accessible computer in communication with an electronic medical records (EMR) database storing, in digitized form, a patient's medical information including at least a prescription medication portfolio compiling a listing of all patient medications, milligram strengths, dosage strengths and frequencies, pill descriptions and refill dates;
a plurality of software template screens linking said physician computer to said EMR database and providing an ability to upload medication related information;
a process server in operative communication with said EMR database and receiving a packet of digitized information incorporating any subset amount of information relative to the patient, said process server issuing a wireless communication to a patient accessible device relative to said packet of information; and
a patient provided and portable USB drive incorporated into at least one of a thumb drive and a flash drive and containing a backup copy of said prescription medication portfolio.
